(19) United States
(12) Patent Application Publication
(10) Pub. No.: US 2025/0156874 A1
(43) Pub. Date: May 15, 2025

(54) GENERATING ESTIMATED FUTURE TRANSACTIONS USING TOKENS AND EMBEDDINGS OF PAST TRANSACTIONS

(71) Applicant: MASTERCARD INTERNATIONAL INCORPORATED, PURCHASE, NY (US)

(72) Inventors: Rohit CHAUHAN, Somers, NY (US); Hardik WADHWA, White Plains, NY (US); Nitendra RAJPUT, Gurugram (IN); Yatin KATYAL, Rohtak (IN)

(21) Appl. No.: 18/940,805

(22) Filed: Nov. 7, 2024

Related U.S. Application Data
(60) Provisional application No. 63/599,491, filed on Nov. 15, 2023.

(51) Int. Cl. G06Q 20/40; G06Q 10/087; G06Q 20/38; G06Q 30/0226

(52) U.S. Cl. CPC G06Q 20/4016; G06Q 10/087; G06Q 20/382; G06Q 30/0231

(57) ABSTRACT

A computerized method analyzes past transactions using machine learning (ML) models. A group of transactions associated with an account is obtained and the group of transactions is converted into a group of transaction strings using a subset of transaction features. For each transaction string in the group of transaction strings, a transaction token based on the transaction string is generated using a token vocabulary of a tokenizer. The generated transaction tokens associated with the group of transaction strings are provided to a ML model as input and an estimated transaction token is generated by the ML model based on the provided transaction tokens. The generated estimated transaction token is transformed into an estimated transaction using a de-tokenizer associated with the tokenizer. A new transaction associated with the account is approved using the estimated transaction, wherein the estimated transaction is compared to the new transaction.

### BACKGROUND

Modern computer systems are often large and complex and can enable many different types of transactions and/or other interactions. However, such systems often suffer from inefficiencies and vulnerability to fraud or other malevolent actions. It is challenging to determine changes that can be made to improve efficiency and/or prevent fraud in such computer systems.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A computerized method for analysis of past transactions using machine learning (ML) models to create solutions to optimize network efficiency, enhance approval rates, mitigate fraud, and enrich customer profiles is described. A group of transactions associated with an account is obtained and the group of transactions is converted into a group of transaction strings using a subset of transaction features. For each transaction string in the group of transaction strings, a transaction token based on the transaction string is generated using a token vocabulary of a tokenizer, wherein the token vocabulary associates transaction strings with transaction tokens. The generated transaction tokens associated with the group of transaction strings are provided to a ML model as input and an estimated transaction token is generated by the ML model based on the provided transaction tokens. The generated estimated transaction token is transformed into an estimated transaction using a de-tokenizer associated with the tokenizer, wherein the estimated transaction is associated with the account with which the obtained group of transactions is associated. A new transaction associated with the account is approved using the estimated transaction, wherein the estimated transaction is compared to the new transaction.

### BRIEF DESCRIPTION OF THE DRAWINGS

The present description will be better understood from the following detailed description read considering the accompanying drawings, wherein:

FIG. 1 is a block diagram illustrating a system configured to tokenize a group of transactions and to use a model to estimate or otherwise predict future transactions based on the tokenized transactions;

FIG. 2 is a diagram illustrating exemplary groups of features and/or variables of transactions;

FIG. 3 is a diagram illustrating details of an exemplary process for transforming data of a transaction into a word and/or token;

FIG. 4 is a diagram illustrating the use of a sequence of transaction tokens, or tokenized transactions, to estimate or otherwise predict one or more of the next future transactions;

FIG. 5 is a diagram illustrating an example system configured to generate estimated transactions based on provided past transactions using a Transaction GPT model with a Cross-Attention Mechanism;

FIG. 6 is a diagram illustrating an example system configured to use a Transaction GPT with multi-modal capabilities to respond to queries;

FIG. 7 is a diagram illustrating an example process of generating feature and/or attribute embeddings for use in estimating future transactions based on past transactions using a transformer model as described herein;

FIG. 8 is a diagram illustrating an example system for transforming transaction data of a transaction sequence into transaction embeddings;

FIG. 9 is a flowchart illustrating an example method for generating an estimated future transaction using tokenization as described herein;

FIG. 10 is a flowchart illustrating an example method for generating an estimated future transaction using embeddings as described herein; and

FIG. 11 illustrates an example computing apparatus as a functional block diagram.

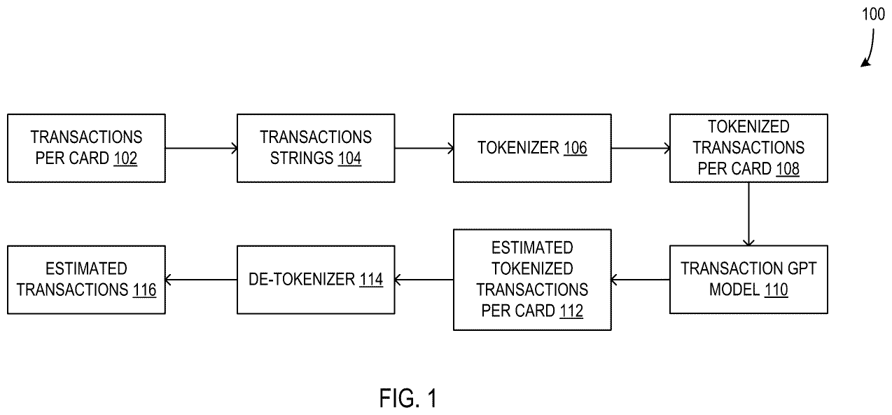

Corresponding reference characters indicate corresponding parts throughout the drawings. In FIGS. 1 to 11, the systems are illustrated as schematic drawings. The drawings may not be to scale. Any of the figures may be combined into a single example or embodiment.

### DETAILED DESCRIPTION

Aspects of the disclosure provide systems and methods for analysis of past transactions using machine learning (ML) models to create solutions to optimize network efficiency, enhance approval rates, mitigate fraud, and enrich customer profiles. In some examples, such systems and methods use advanced techniques such as Graphs, Language Models (LLMs), Transformers, and/or Generative Adversarial Networks (GANs). Some initial examples provide promising results, such as at or around a 35% improvement in fraud detection and/or at or around a 50% increased accuracy at estimating, forecasting, or otherwise predicting a next customer transaction. It should be understood that any specific degrees of improvement are associated with examples of the disclosure and, in other examples, other degrees of improvement (e.g., to fraud detection and/or accuracy) may result from the use of the disclosed systems/methods without departing from the disclosure.

In some examples, the disclosure includes the analysis of past transaction data by converting the variables or features of transactions into tokens and/or embeddings which can then be processed by ML models as described herein. In examples using a described tokenization approach, numerical and categorical elements of the transactions are selected for use in generating transaction tokens, In an example, the tokens are set combinations of Industry×Region×Channel×etc.

In examples using a described embedding approach, embeddings (e.g., numerical vectors that represent words or other units of information that are used in ML and/or artificial intelligence (AI) systems) are generated in such a way as to reduce the size of distinct data values that are relatively large (e.g., issuer variables, merchant variables, acquirer variables). Modeling is focused on the embeddings that are generated from the data values of the transactions, such that embeddings of past transactions are used to estimate an embedding of the next transaction. That estimated embedding can then be used to construct the features and variables of the estimated next transaction.

The disclosure operates in an unconventional manner, at least by improving the computing speed of associated processes. In some examples, approval time of transactions is reduced, benefiting both consumers and businesses. Further, in some examples, the reduction in approval time also benefits the associated issuers and acquirers while also enabling real-time updating. Additionally, the described system uses reduced computing resources and/or other system resources to evaluate transaction patterns for fraud when compared to other systems that do not use the described methods of generating estimated transactions.

Further, in some examples, the disclosure enables the use of personalization to enhance user experience. In some examples, the disclosure enables the generation of personalized recommendations for users and enables merchants to tailor and customize promotional offers to customers in real time, improving the customer experience.

In some examples, the disclosure enhances security of the associated transaction processing systems. In an example, the disclosure enables the merchants, issuers, and/or acquirers to generate preemptive fraud indications for future transactions and/or to reduce the occurrence of fraud and chargebacks through the increased computational efficiency of the transaction processing systems.

In some examples, the disclosure is applied to inventory management processes, whereby estimated or otherwise predicted transactions are used to better maintain accurate inventories with which customer demands can be met.

In some examples, the disclosure is applied to carbon emission data to recommend more environmentally friendly routes and spending choices.

In some examples, the disclosure is applied to labor management processes. For instance, by estimating quantities of future transactions at specific locations, the quantity of needed staff to handle the demand can be forecasted and scheduled to efficiently manage the costs associated with labor.

In some examples, the disclosure is applied to supply chains, whereby demand for specific products or other entities is estimated and those estimations are used to manage the supply of those demanded products or other entities.

In some examples, the disclosure is applied to philanthropy management, whereby the disclosure is used to more efficiently manage funds based on estimations of number of donations.

In some examples, the disclosure is applied to government management, whereby the disclosure is used to determine expected tax revenues based on individual spending forecasts.

It should be understood that, while in many described examples, the systems and methods herein are applied to payment transaction data, in other examples, the systems and methods are applied to other types of sequential and/or transactional data without departing from the description.

FIG. 1 is a block diagram illustrating a system 100 configured to tokenize a group of transactions 102 and to use a model 110 to estimate or otherwise predict future transactions 116 based on the tokenized transactions 108 in some examples. For a particular card and/or account, a group of transactions 102 are identified. The features and/or variables associated with the transactions 102 of the identified group are determined and a subset of those features and/or variables are selected. The selected subset of transaction features are combined into transaction strings 104, or “words”, for each transaction (e.g., transactions as words). The strings 104 are then transformed into tokens, or tokenized transactions 108, using a tokenizer 106. The group of tokenized transactions 108 are then provided to a trained ML model 110 (e.g., a Transaction Generative Pre-trained Transformer (GPT) model) as input and the trained ML model 110 generates at least one tokenized transaction of an estimated future transaction 112. A de-tokenizer 114 associated with the tokenizer 106 is used to convert the generated tokenized transaction 112 of the estimated future transaction into an estimated transaction 116 as illustrated, wherein the estimated transaction 116 includes a group of transaction features (e.g., the selected subset of features and/or variables used previously in the described process). In some examples, the subset of features and/or variables are selected based on a defined vocabulary of the tokenizer 106, such that, for each transaction, the combination of the features as a string can be mapped or otherwise associated with a specific token in the vocabulary of the tokenizer 106. Further, as a result of the use of the tokenizer 106 and de-tokenizer 114, the tokenized transaction 112 generated by the trained ML model 110 is a token of the vocabulary of the tokenizer 106 as well.

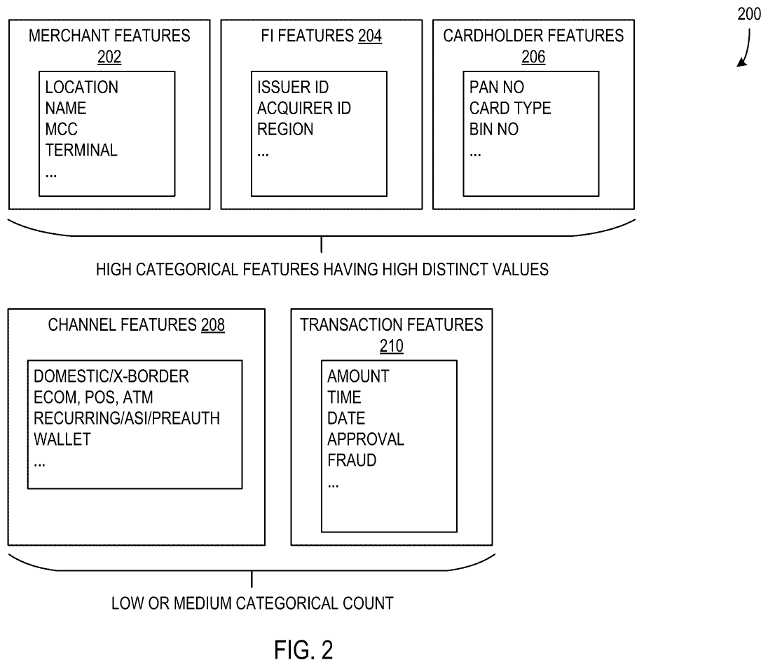

FIG. 2 is a diagram 200 illustrating exemplary groups of features and/or variables of transactions. In some examples, the features and/or variables of transactions are grouped based on parties to the transactions. As illustrated, such features are grouped as merchant features 202, issuer and/or acquirer features 204, cardholder features 206, channel features 208, and/or transaction features 210. In some such examples, merchant features 202 include location, name, merchant category code (MCC), and/or terminal. In some such examples, issuer and/or acquirer features 204 include issuer ID, acquirer ID, and/or region. In some such examples, cardholder features 206 include Primary Account Number (PAN), Card Type, and/or Bank Identification Number (BIN). In some such examples, channel features 208 include Domestic/Cross-border indicators, channel type (e.g., e-commerce, Point of Sale (POS), Automated Teller Machine (ATM)), wallet identifier, other transaction features (e.g., recurring transaction indicators, account status inquiry (ASI) indicators, pre-authorization indicators). In some such examples, the transaction features 210 include transaction amount values, time, date, approval data features, and/or fraud indicators. It should be understood that, in other examples, more, fewer, or different types of transaction features and/or variables are used without departing from the description. Further, in some examples, different subgroups of transaction features are used for different purposes (e.g., the channel features and/or the transaction features are used with a tokenization approach, such as the approach described in FIG. 1, due to having relatively low category counts while other subgroups of features are used with an embedding approach, such as the embedding approaches described in greater detail below).

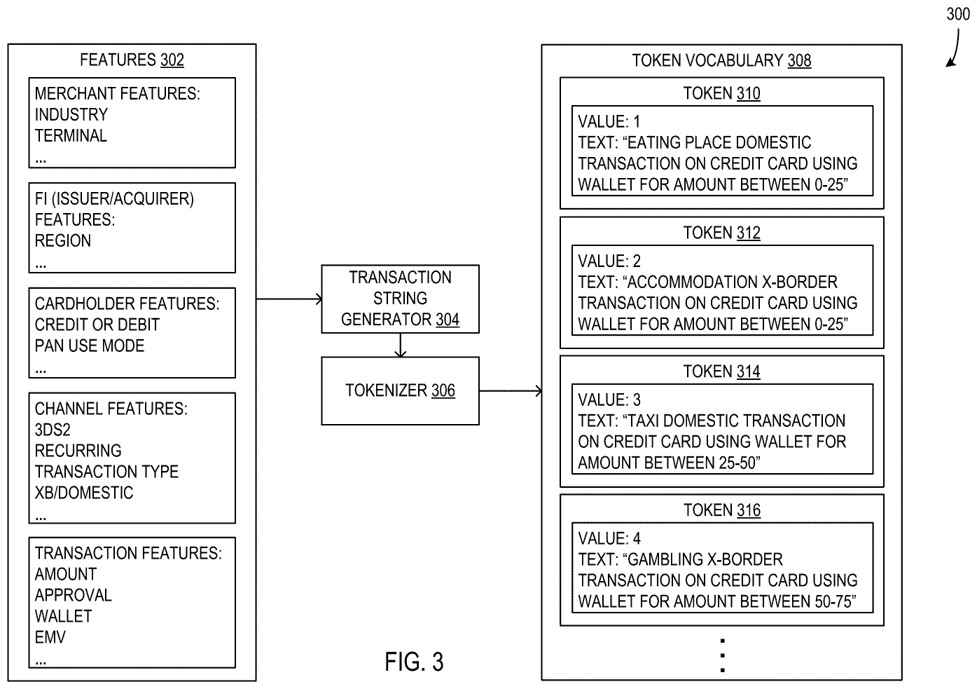

FIG. 3 is a diagram illustrating details of an exemplary process 300 for transforming data of a transaction into a word and/or token. On the left of the diagram, a group of possible transaction features 302 that are used during the generation of strings or words by the transaction string generator 304 for tokenization in some examples are shown. On the right, resulting strings or words are shown in association with token values of those resulting strings or words to form the token vocabulary 308 of the tokenizer 306. For instance, token 310 includes the first string of “Eating place domestic transaction on credit card using wallet for amount between 0-25” and the associated token value in the vocabulary 308 of the tokenizer 306 is 1. In some such examples, the tokenizer 306 is configured to have a vocabulary of ˜200 k tokens, with each token 310-316 being associated with a string that identifies features of specific transactions. Three other example strings and associated tokens are also illustrated with respect to tokens 312, 314, and 316, but in other examples, more, fewer, or different strings and/or tokens are used without departing from the description.

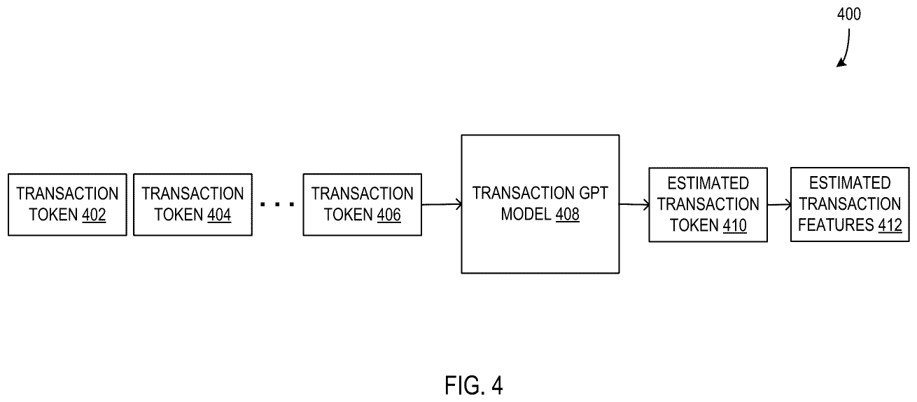

FIG. 4 is a diagram 400 illustrating the use of a sequence of transaction tokens 402-406, or tokenized transactions, to estimate or otherwise predict one or more of the next future transactions. In some examples, the series of transaction tokens 402-406, including transaction token 404, on the left are provided to a transformer model 408 (e.g., a Transaction Generative Pre-Trained (GPT) Model). The transformer model 408 then generates an estimated transaction token 410 based on its training. The transaction token 410 is then de-tokenized or otherwise converted into transaction features 412 of the estimated transaction as described herein. Further, in some examples, the scale of such an example system includes 1 billion cards and/or accounts and associated 500+ Billion transactions. These accounts and associated transactions are used with the multi-billion parameter transformer model 408 to estimate or otherwise predict one or more future transactions for at least some of those cards and/or accounts. The estimated transactions and associated feature data (e.g., estimated transaction features 412) can then be used for such purposes as described herein. Further, in some examples, at least a portion of those 500+ Billion transactions are used to train the transformer model 408, wherein the transformer model 408 is trained and/or fine-tuned for accuracy in estimating or otherwise predicting transactions as described herein.

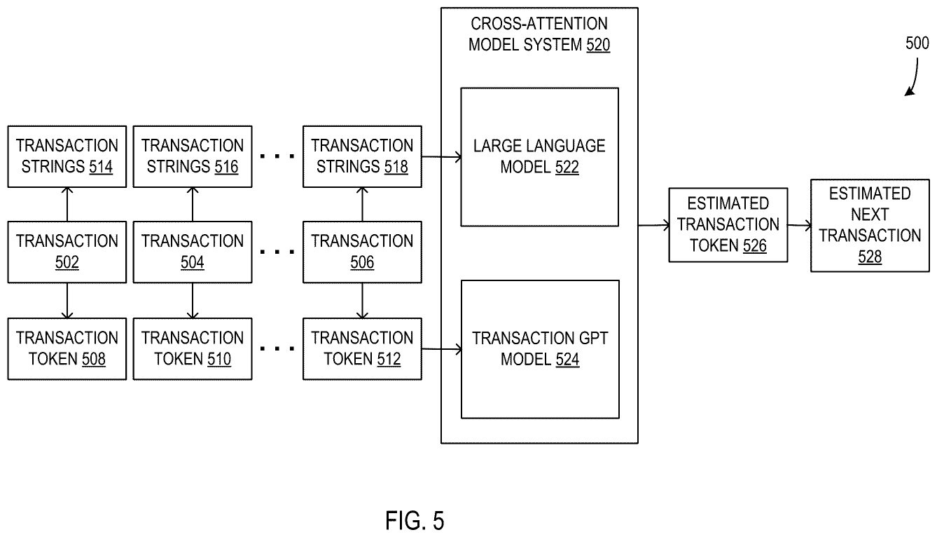

FIG. 5 is a diagram illustrating an example system 500 configured to generate estimated transactions based on provided past transactions 502-506 using a Transaction GPT model 524 with a Cross-Attention Mechanism (e.g., the cross-attention model system 520). A group of transactions 502-506, including transaction 504, is provided to the system 500 and the features of the transactions 502-506 are used to generate tokenized transactions, or transaction tokens 508-512, including transaction token 510, using a tokenizer (e.g., tokenizer 106) as described herein. Further, the data of the transactions is used to generate transaction strings 514-518, including transaction string 516, of the transactions 502-506 using a Natural Language Processing (NLP) engine. The strings 514-518 are provided to a Large Language Model (LLM) 522 and the output is analyzed in conjunction with the tokenized transactions 508-512 using a series of stacked decoders. The stacked decoders output a transaction token 526 of an estimated next transaction 528 as described herein. It should be understood that cross-attention techniques are used by the system 500 during the generation of the transaction token output such that both the transaction tokens 508-512 of the input transactions and the strings 514-518 of the input transactions are used in the generation of the estimated transactions. Further, in some examples, the Transaction GPT model 524 is or includes a multi-modal model, such that the model is configured to receive input in multiple different modalities.

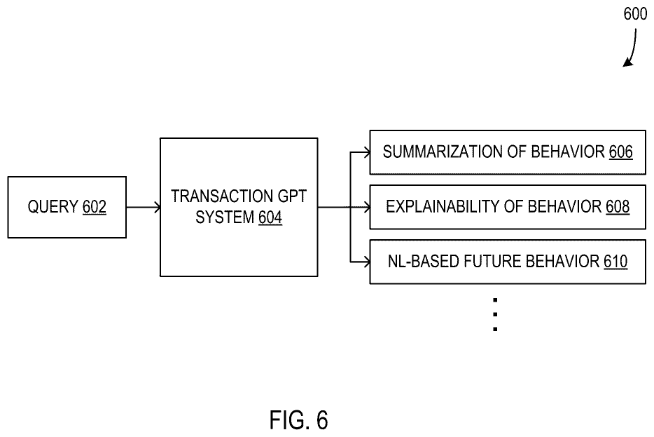

FIG. 6 is a diagram illustrating an example system 600 configured to use a Transaction GPT 604 with multi-modal capabilities to respond to queries 602. In some examples, a query 602 is provided to Transaction GPT 604, which then generates answers to the query in the form of a summarization of customer behavior 606, an explanation of customer behavior 608, a natural language (NL) estimation or prediction of future customer behavior 610, and/or other types of responses. Example query-answer use cases are described below, providing two example questions and corresponding example answers that are generated by the illustrated system.

One use case includes a query-answer combination that illustrates the explainability of customer behavior. The query is “Can you explain the reason behind the possible decline of transaction A for card X?” and the associated answer is “The customer transaction conducted significantly deviated from usual customer behavior with a major drift in channel and industry based on time of day.”

Another use case includes a query-answer combination that illustrates NL-based estimation of future customer behavior. The query is “The customer does high frequency transactions of types grocery and ATM. The card used by the customer is credit card X. Most transactions are domestic with few cross-border transactions. The preferred channels are contactless and e-commerce. The customer has two recurring transactions monthly. What is the future growth of the customer?” and the associated answer is “Customer is expected to do more recurring transactions in industries like digital media and payments. The customer will drift behavior into more cross-border transactions.”

In other examples, the described systems and methods are extended to work with large language models (LLMs) and/or to use text, images, and/or other modalities as input and output. Such integration is achieved by designing an architecture comprising cross-attention layers that inject transaction representations within the language model. During the training phase, the transaction parameters are updated while keeping the language model parameters static and vice versa. This methodology facilitates the seamless incorporation of transaction data, resulting in a robust system capable of processing and understanding both textual and transactional information.

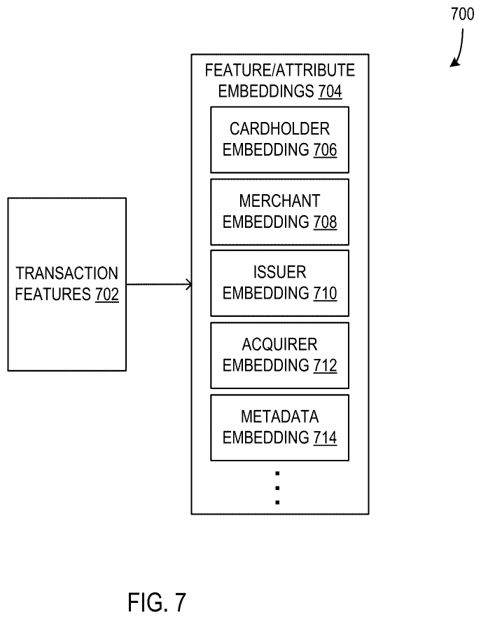

FIG. 7 is a diagram illustrating an example process 700 of generating feature and/or attribute embeddings 704 for use in estimating future transactions based on past transactions using a transformer model as described herein. It should be understood that embeddings 704 are numerical vectors representing objects, entities, and/or relationships. In some examples, features 702 of transactions, such as entity-level representations of transaction data (e.g., cardholder, issuer, acquirer, and/or merchant-related features) are obtained and the data of those features 702 is transformed into vector embeddings 704. For instance, a separate vector embedding 704 is generated for each group of transaction features 702, such as a cardholder embedding 706, a merchant embedding 708, an issuer embedding 710, an acquirer embedding 712, and/or a metadata embedding 714. The generated embeddings 704 are provided as input to a trained transformer model (e.g., Transaction GPT model as described herein). The transformer model is trained to generate one or more probable transactions and/or probable sequences of transactions given the past transaction history. Further, in some examples, embeddings are generated using transaction metadata and used with or instead of the embeddings described above in generating the probable transactions.

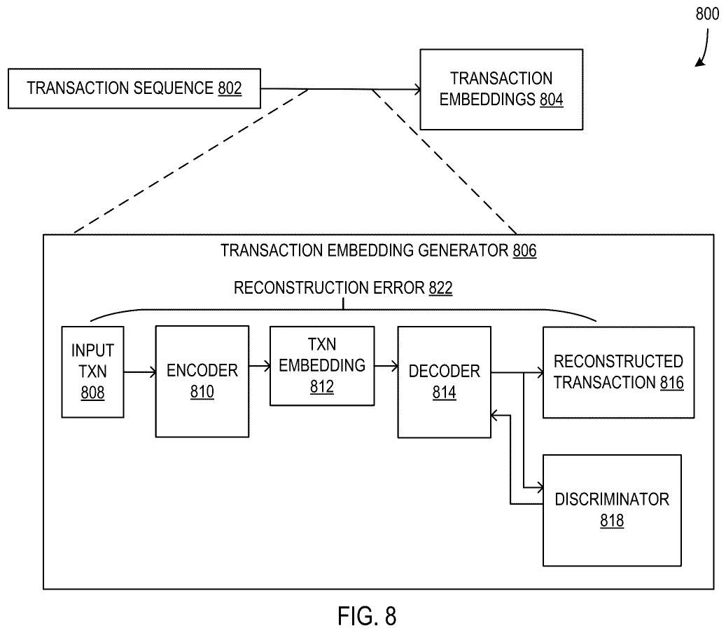

Further, in some examples, the feature/attribute embeddings 704 are used to generate transaction embeddings associated with a continuous transaction embedding manifold as described below with respect to FIG. 8.

FIG. 8 is a diagram illustrating an example system 800 for transforming transaction data of a transaction sequence 802 into transaction embeddings 804. In some examples, the data of a sequence of transactions 802 is provided to a transaction embedding generator 806 (e.g., Txn2Vec). The generator 806 provides transaction data of an input transaction 808 to an encoder 810 to generate a transaction embedding 812. The transaction embedding 812 is then provided to a decoder 814 to generate a reconstructed transaction 816 with associated transaction data. The reconstructed transaction 816 is compared to the input transaction 808 to find the reconstruction error 822 and the encoder and/or decoder are adjusted or otherwise trained based on reconstruction error 822 and/or other differences between the reconstructed transaction 816 and the input transaction 808. In some such examples, embeddings 812 of the sequence of transactions are evaluated as a trajectory in an embedding manifold. When the transaction embedding generator 806 performs with a required level of accuracy, it can be used to generate embeddings 804 for use in estimating or otherwise predicting future transactions as described herein. Further, in some examples, the transaction embedding generator 806 includes a discriminator 818 that is used to aid in the training of the encoder 810 and decoder 814 by providing feedback to the encoder 810 and decoder 814 based on the accuracy of the reconstructed transaction 816.

Additionally, or alternatively, in some examples, the generator 806 is used with a masked layer model, such as a bidirectional encoder representation, for learning transaction representations. In some examples, the generator 806 is used to estimate or otherwise determine whether the next transaction in a sequence is genuine (e.g., the transaction is approved, not a fraudulent transaction, and/or includes no chargeback). In some examples, the embeddings generated by the generator 806 are used to match similar transactions and/or support multiple downstream models. In some examples, the generator 806 is used as part of or otherwise in conjunction with Generative Adversarial Networks (GANs).

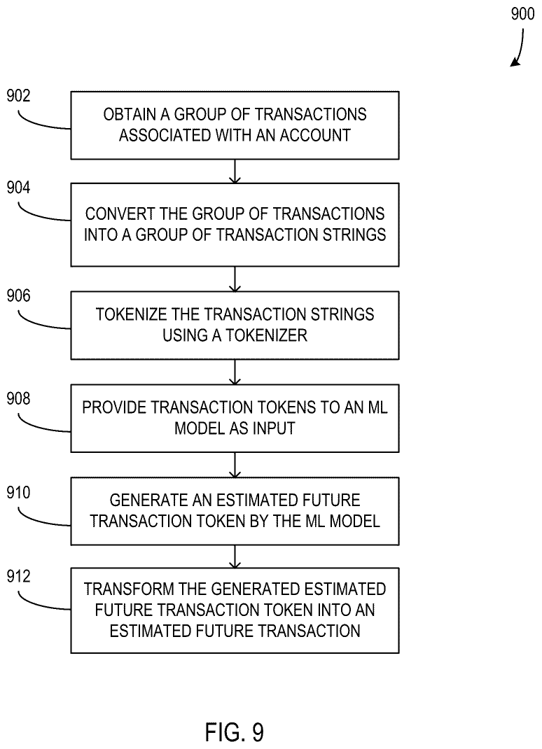

FIG. 9 is a flowchart illustrating an example method 900 for generating an estimated future transaction using tokenization as described herein. In some examples, the method 900 is executed or otherwise performed in a system such as the systems described herein.

At 902, a group of transactions associated with an account (e.g., a credit card account) is obtained.

At 904, each transaction in the group of transactions is converted into a transaction string. In some examples, the transaction string is generated from a defined subset of transaction features of each transaction in order to ensure that the transaction string matches or maps to a token of the tokenizer vocabulary.

At 906, each transaction string is tokenized using the tokenizer, which has a limited vocabulary for converting specific transaction strings to transaction tokens.

At 908, the transaction tokens are provided to an ML model as input and, at 910, an estimated future transaction token is generated by the ML model based on the provided transaction tokens. In some examples, the ML model generates multiple estimated transaction tokens (e.g., multiple transaction tokens that might be the next transaction and/or a series of multiple transaction tokens that represent an estimated or otherwise predicted series of transactions).

At 912, the generated estimated future transaction token is transformed into an estimated future transaction using a de-tokenizer. In some examples, the de-tokenizer uses the same vocabulary as the tokenizer to detokenize the estimated future transaction token. Further, the estimated transaction can then be used to detect possible fraud or for other purposes as described herein.

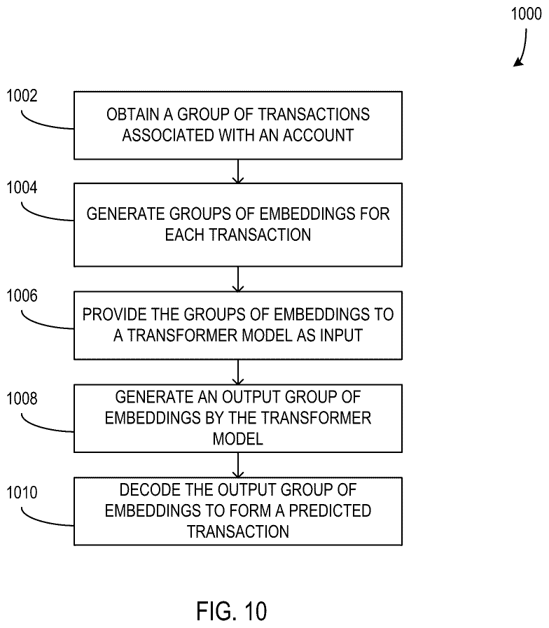

FIG. 10 is a flowchart illustrating an example method 1000 for generating an estimated future transaction using embeddings as described herein. In some examples, the method 1000 is executed or otherwise performed in a system such as the systems described herein.

At 1002, a group of transactions associated with an account is obtained.

At 1004, groups of embeddings are generated for each transaction in the group of transactions. In some examples the groups of embeddings include embeddings associated with transaction feature subsets from or associated with different parties to the transactions (e.g., cardholder embeddings, merchant embeddings, issuer embeddings, and/or acquirer embeddings).

At 1006, the groups of embeddings are provided to a transformer model as input and, at 1008, an output group of embeddings is generated by the transformer model based on the provided groups of embeddings.

At 1010, the output group of embeddings are decoded to form an estimated future transaction, wherein the estimated future transaction indicates a likely future transaction of the account with which the obtained group of transactions are associated.

### Additional Use Case Examples

In some examples, the described Transaction GPT models are used for synthetic fraud generation, dark web activity monitoring, and/or reducing fraud false positives. In an example, synthetic fraud is generated and provided to issuers to test robustness and/or vulnerabilities of their existing fraud detection systems. Dynamic fraud rule generation enables issuers and/or acquirers to request the generation of fraud rules based on pre-defined fraud criteria (e.g., location, channel, merchant, etc.) using Transaction GPT as described herein.

In another example, Transaction GPT is used as a proactive alerting system for dark web activities. With fresh dark web information provided to Transaction GPT, the scope of the system is configured to estimate or otherwise predict the next transaction by a user on a dark web merchant that can lead to stolen information, fraud, and/or chargebacks. In some such examples, Transaction GPT is configured to propose counter measures to limit fraudulent and malevolent activities that are estimated.

Additionally, in another example, Transaction GPT is used to reduce the occurrence of declined transactions which are non-fraudulent but that are declined due to sudden changes in spending patterns. In such examples, Transaction GPT is configured to estimate or otherwise predict such transactions

Further, in some examples, the described models are incorporated with existing models to provide technical enhancements as described. As described, Transaction GPT is configured to learn intricate patterns among transactions, merchants, issuers, acquirers, and cardholders. Rich embeddings are created using the same that can be used in downstream tasks, such as tasks for enhancing fraud, risk, and/or other predictive artificial intelligence (AI) models. Additionally, in some examples, Transaction GPT is used to generate features which are not available at the time of authorization for real time model scoring. Still further, in some examples, deviations in expected next transactions and actual transactions, determined based on output from Transaction GPT models, are used as indicators for unusual patterns in cardholders' profiles and the same transactions are marked as risky or fraudulent.

Additionally, or alternatively, the described Transaction GPT models are used to estimate or otherwise predict potential attrition of customers, such that customers that are at risk of attrition can be given more attention. In an example, using Transaction GPT models, factors such as upcoming transaction dates, frequency and amount of purchase are predicted for cardholders. If the actual behavior of the cardholder does not align with the predicted behavior, especially in terms of transaction frequency, the customer can be considered as likely to be lost through attrition and the segment of customers can be given more attention to try to prevent such attrition.

In some examples, the described Transaction GPT models are used for inventory management, network, and hardware monitoring, improving authorization rates, merchant cleansing, and/or data enrichment. In an example, Transaction GPT models are used to integrate inventory management system with the transaction foundation model. Based on past data, the model estimates or otherwise predicts when a merchant might run out of a particular item and suggest optimal reordering levels. In another example, an automated teller machine (ATM) has a cash disbursement system, in which the bank must refill the cash at the ATM terminals time and time again. The normal procedure is the issuance of a notification that the terminal has become out of cash. Transaction GPT models are configured to predict the volume of transactions happening at a particular ATM terminal in the nearby future and to inform the bank about the time in which the ATM machine will likely run out of cash. Thus, the bank is enabled take the informed decision based on this information.

Further, in some examples, Transaction GPT models are used in network and hardware monitoring to identify vulnerabilities in servers, both at Issuer MASTERCARD Interface Processor (MIP) or Acquiring MIP side and start estimating or otherwise predicting transactions that reflect more of server related failures. For instance, if the transactions predicted by Transaction GPT models have increasing declines due to server timeout or suggest increased Stand-In/X-code activity, this can be an early indication of an underlying problem.

Additionally, in some examples, Transaction GPT models are used to reduce “non-sufficient funds” (NSF) declined transactions by leveraging the amount of the next transactions. Issuers are enabled to compare the available balance and recommend “topping up” to avoid future declines for cardholders. Further, the Transaction GPT models can be used to recommend specific products that increase approval chances for associated authorizations.

In other examples, Transaction GPT models are configured to enable the matching of the same merchant using transactions originating from different acquirers and/or under different IDs or names. Additionally, or alternatively, Transaction GPT models are configured to estimate or otherwise predict results that help identify improperly configured/missing data elements by acquirers and to help those acquirers correct issues using the Transaction GPT model-powered prediction engine.

In some examples, the described Transaction GPT models are used for estimating or otherwise predicting customer behavior in the form of natural language, estimating or otherwise predicting new channel opportunities, and/or providing personalized customer experiences.

In an example, the transaction and history of a merchant and cardholder are converted into natural language and fed into the transformer. The Transaction GPT system estimates or otherwise predicts subsequent behavior of the cardholder, merchant, and/or associated transactions in natural language. Thus, the described system is used as a bot for customers, issuers, and/or acquirers to ask for relevant details which will provide transaction information. For instance, Transaction GPT is used to estimate or otherwise predict the next transaction in natural language, such as “The next transaction is likely to be a purchase of groceries at Store A.” Additionally, or alternatively, Transaction GPT is used to assess the risk and loyalty factors of a transaction, such as “This transaction is high-risk because it is a large purchase from an unfamiliar merchant.” Further, in some examples, Transaction GPT is used to provide recommendations to merchants and customers, such as “We recommend offering this customer a loyalty discount on their next purchase.” Additionally, in some examples, the system is configured to explain why the transaction was declined.

In another example, the Transaction GPT models are used to estimate or otherwise predict potential new channels of payment, such as “smile to pay”, contactless payments, or the like. Such estimation enables systems to increase customer engagement.

In yet another example, the Transaction GPT models are used to estimate or otherwise predict card-level transactions such that customer behavior is captured. Using this captured customer behavior, companies are enabled to offer special deals, rewards, and suggestions to incentivize each customer. Customer churn is reduced in recurring services and sales are increased by retaining customers in other non-subscription-based services.

Further, in some examples, the described Transaction GPT models are used for providing and/or enhancing explainability and interpretability, aggregation of predictions, and/or integration of ChatGPT or other similar models with Transaction GPT models to solve multiple customer problems.

In an example, Transaction GPT models are used to estimate or otherwise predict future transactions and also identify factors responsible for the occurrence of the future transactions. These factors are used to improve the transparency and accuracy of existing ML models and/or other products.

In another example, Transaction GPT models are used to estimate or otherwise predict more than one future transaction at a granular level. This granular estimation enables a detailed bottom-up revenue estimation for not only issuers, but also for merchants, acquirers, and processors that want to know predictive analytics around transactions in a dynamic manner.

In yet another example, the Transaction GPT models are combined with ChatGPT or other similar language models, such that they are trained side-by-side to use as a Transaction Investigator tool for customers. Transaction-level details are often provided by customers, customer support staff, and/or various product teams for any transaction impacted by a particular service, this Transaction Investigator tool is configured to efficiently return the relevant transaction based a text prompt from a user.

### Exemplary Operating Environment

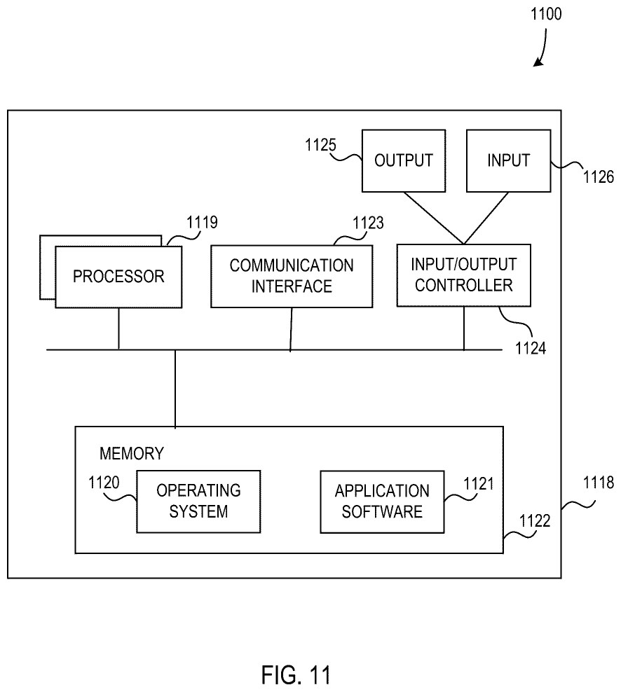

The present disclosure is operable with a computing apparatus according to an embodiment as a functional block diagram 1100 in FIG. 11. In an example, components of a computing apparatus 1118 are implemented as a part of an electronic device according to one or more embodiments described in this specification. The computing apparatus 1118 comprises one or more processors 1119 which may be microprocessors, controllers, or any other suitable type of processors for processing computer executable instructions to control the operation of the electronic device. Alternatively, or in addition, the processor 1119 is any technology capable of executing logic or instructions, such as a hard-coded machine. In some examples, platform software comprising an operating system 1120 or any other suitable platform software is provided on the apparatus 1118 to enable application software 1121 to be executed on the device. In some examples, estimating or otherwise predicting future transactions as described herein is accomplished by software, hardware, and/or firmware.

In some examples, computer executable instructions are provided using any computer-readable media that is accessible by the computing apparatus 1118. Computer-readable media include, for example, computer storage media such as a memory 1122 and communications media. Computer storage media, such as a memory 1122, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media does not include communication media. Therefore, a computer storage medium does not include a propagating signal. Propagated signals are not examples of computer storage media. Although the computer storage medium (the memory 1122) is shown within the computing apparatus 1118, it will be appreciated by a person skilled in the art, that, in some examples, the storage is distributed or located remotely and accessed via a network or other communication link (e.g., using a communication interface 1123).

Further, in some examples, the computing apparatus 1118 comprises an input/output controller 1124 configured to output information to one or more output devices 1125, for example a display or a speaker, which are separate from or integral to the electronic device. Additionally, or alternatively, the input/output controller 1124 is configured to receive and process an input from one or more input devices 1126, for example, a keyboard, a microphone, or a touchpad. In one example, the output device 1125 also acts as the input device. An example of such a device is a touch sensitive display. The input/output controller 1124 may also output data to devices other than the output device, e.g., a locally connected printing device. In some examples, a user provides input to the input device(s) 1126 and/or receives output from the output device(s) 1125.

The functionality described herein can be performed, at least in part, by one or more hardware logic components. According to an embodiment, the computing apparatus 1118 is configured by the program code when executed by the processor 1119 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, or the like) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

An example system comprises a processor; and a memory comprising computer program code, the memory and the computer program code configured to cause the processor to: obtain a group of transactions associated with an account; convert the group of transactions into a group of transaction strings using a subset of transaction features of the group of transactions; for each transaction string in the group of transaction strings, generate a transaction token based on the transaction string using a token vocabulary of a tokenizer, wherein the token vocabulary associates transaction strings with transaction tokens; provide the generated transaction tokens associated with the group of transaction strings to a machine learning (ML) model as input; generate, by the ML model, an estimated transaction token based on the provided transaction tokens; transform the generated estimated transaction token into an estimated transaction using a de-tokenizer associated with the tokenizer, wherein the estimated transaction is associated with the account with which the obtained group of transactions is associated; and approve a new transaction associated with the account using the estimated transaction, wherein the estimated transaction is compared to the new transaction.

An example computerized method comprises obtaining a group of transactions associated with an account; for each transaction in the group of transactions, generating a group of embeddings using subsets of transaction features; providing the groups of embeddings associated with the group of transactions to a transformer model as input; generating, by the transformer model, an output group of embeddings based on the provided groups of embeddings; decoding the output group of embeddings to form an estimated transaction, wherein the estimated transaction is associated with the account with which the obtained group of transactions is associated; and approving a new transaction associated with the account using the estimated transaction, wherein the estimated transaction is compared to the new transaction.

A computer storage medium has computer-executable instructions that, upon execution by a processor, cause the processor to at least: obtain a group of transactions associated with an account; convert the group of transactions into a group of transaction strings using a subset of transaction features of the group of transactions; for each transaction string in the group of transaction strings, tokenize the transaction string using a tokenizer to obtain an associated transaction token, wherein the tokenizer includes a token vocabulary that associates transaction strings with transaction tokens; provide transaction tokens associated with the group of transaction strings to an ML model as input; generate, by the ML model, an estimated transaction token based on the provided transaction tokens; transform the generated estimated transaction token into an estimated transaction using a de-tokenizer associated with the tokenizer, wherein the estimated transaction is associated with the account with which the obtained group of transactions is associated; and approve a new transaction associated with the account using the estimated transaction, wherein the estimated transaction is compared to the new transaction.

Alternatively, or in addition to the other examples described herein, examples include any combination of the following:
wherein converting the group of transactions into the group of transaction strings using a subset of transaction features of the group of transactions includes: identifying a numeric transaction feature of the subset of transaction features; determining a numeric value of the identified numeric transaction feature for a transaction of the group of transactions; and converting the determined numeric value of the identified numeric transaction feature into a categorical feature value of a categorical feature that is associated with a numeric value range of the numeric transaction feature, wherein the transaction string of the transaction includes the categorical feature value to which the determined numeric value was converted.
wherein approving the new transaction associated with the account using the estimated transaction includes: generating an approval notification associated with the new transaction; and causing the generated approval notification to be sent to one or more entities associated with the new transaction, wherein the one or more entities associated with the new transaction include a merchant, an acquirer, or an issuer.
further comprising: estimating future account behavior of the account using the estimated transaction; determining that the estimated future account behavior indicates a reduction in user loyalty with respect to the account; and recommending a promotional offer to be offered to a user of the account, whereby the reduction in user loyalty with respect to the account is less likely.
further comprising: generating, by the ML model, a second estimated transaction token based on the provided transaction tokens; transforming the second generated estimated transaction token into a second estimated transaction using a de-tokenizer associated with the tokenizer, wherein the second estimated transaction is associated with the account with which the obtained group of transactions is associated; determining a difference between the second estimated transaction and a second new transaction associated with the account exceeds a threshold; and generating a preemptive fraud indicator based on the determined difference exceeding the threshold.
further comprising: generating an inventory management indicator associated with the estimated transaction, wherein the inventory management indicator indicates, to a receiving merchant, a need to order an item with which the estimated transaction is associated; and causing the generated inventory management indicator to be sent to a merchant with which the estimated transaction is associated.
further comprising: receiving a natural language query associated with the account; generating a natural language query response based on the estimated transaction; and responding to the received natural language query with the generated natural language response.
further comprising: generating, by the transformer model, a second output group of embeddings based on the provided groups of embeddings; transforming the second output group of embeddings to form a second estimated transaction, wherein the second estimated transaction is associated with the account with which the obtained group of transactions is associated; determining a difference between the second estimated transaction and a second new transaction associated with the account exceeds a threshold; and generate a preemptive fraud indicator based on the determined difference exceeding the threshold.

Any range or device value given herein may be extended or altered without losing the effect sought, as will be apparent to the skilled person.

Examples have been described with reference to data monitored and/or collected from the users (e.g., user identity data with respect to profiles). In some examples, notice is provided to the users of the collection of the data (e.g., via a dialog box or preference setting) and users are given the opportunity to give or deny consent for the monitoring and/or collection. The consent takes the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute an exemplary means for obtaining a group of transactions associated with an account; an exemplary means for converting the group of transactions into a group of transaction strings using a subset of transaction features of the group of transactions; for each transaction string in the group of transaction strings, an exemplary means for generating a transaction token based on the transaction string using a token vocabulary of a tokenizer, wherein the token vocabulary associates transaction strings with transaction tokens; an exemplary means for providing the generated transaction tokens associated with the group of transaction strings to a machine learning (ML) model as input; an exemplary means for generating, by the ML model, an estimated transaction token based on the provided transaction tokens; an exemplary means for transforming the generated estimated transaction token into an estimated transaction using a de-tokenizer associated with the tokenizer, wherein the estimated transaction is associated with the account with which the obtained group of transactions is associated; and an exemplary means for approving a new transaction associated with the account using the estimated transaction, wherein the estimated transaction is compared to the new transaction.

The term “comprising” is used in this specification to mean including the feature(s) or act(s) followed thereafter, without excluding the presence of one or more additional features or acts.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system comprising:
a processor; and
a memory comprising computer program code, the memory and the computer program code configured to cause the processor to:
obtain a group of transactions associated with an account;
convert the group of transactions into a group of transaction strings using a subset of transaction features of the group of transactions;
for each transaction string in the group of transaction strings, generate a transaction token based on the transaction string using a token vocabulary of a tokenizer, wherein the token vocabulary associates transaction strings with transaction tokens;
provide the generated transaction tokens associated with the group of transaction strings to a machine learning (ML) model as input;
generate, by the ML model, an estimated transaction token based on the provided transaction tokens;
transform the generated estimated transaction token into an estimated transaction using a de-tokenizer associated with the tokenizer, wherein the estimated transaction is associated with the account with which the obtained group of transactions is associated; and
approve a new transaction associated with the account using the estimated transaction, wherein the estimated transaction is compared to the new transaction.

2. The system of claim 1, wherein converting the group of transactions into the group of transaction strings using a subset of transaction features of the group of transactions includes:
identifying a numeric transaction feature of the subset of transaction features;
determining a numeric value of the identified numeric transaction feature for a transaction of the group of transactions; and
converting the determined numeric value of the identified numeric transaction feature into a categorical feature value of a categorical feature that is associated with a numeric value range of the numeric transaction feature, wherein the transaction string of the transaction includes the categorical feature value to which the determined numeric value was converted.

3. The system of claim 1, wherein approving the new transaction associated with the account using the estimated transaction includes:
generating an approval notification associated with the new transaction; and
causing the generated approval notification to be sent to one or more entities associated with the new transaction, wherein the one or more entities associated with the new transaction include a merchant, an acquirer, or an issuer.

4. The system of claim 1, wherein the memory and the computer program code are configured to further cause the processor to:
estimate future account behavior of the account using the estimated transaction;
determine that the estimated future account behavior indicates a reduction in user loyalty with respect to the account; and
recommend a promotional offer to be offered to a user of the account, whereby the reduction in user loyalty with respect to the account is less likely.

5. The system of claim 1, wherein the memory and the computer program code are configured to further cause the processor to:
generate, by the ML model, a second estimated transaction token based on the provided transaction tokens;
transform the second generated estimated transaction token into a second estimated transaction using a de-tokenizer associated with the tokenizer, wherein the second estimated transaction is associated with the account with which the obtained group of transactions is associated;
determine a difference between the second estimated transaction and a second new transaction associated with the account exceeds a threshold; and
generate a preemptive fraud indicator based on the determined difference exceeding the threshold.

6. The system of claim 1, wherein the memory and the computer program code are configured to further cause the processor to:
generate an inventory management indicator associated with the estimated transaction, wherein the inventory management indicator indicates, to a receiving merchant, a need to order an item with which the estimated transaction is associated; and
cause the generated inventory management indicator to be sent to a merchant with which the estimated transaction is associated.

7. The system of claim 1, wherein the memory and the computer program code are configured to further cause the processor to:
receive a natural language query associated with the account;
generate a natural language query response based on the estimated transaction; and
respond to the received natural language query with the generated natural language response.

8. A computerized method comprising:
obtaining a group of transactions associated with an account;
for each transaction in the group of transactions, generating a group of embeddings using subsets of transaction features;
providing the groups of embeddings associated with the group of transactions to a transformer model as input;
generating, by the transformer model, an output group of embeddings based on the provided groups of embeddings;
decoding the output group of embeddings to form an estimated transaction, wherein the estimated transaction is associated with the account with which the obtained group of transactions is associated; and
approving a new transaction associated with the account using the estimated transaction, wherein the estimated transaction is compared to the new transaction.

9. The computerized method of claim 8, wherein approving the new transaction associated with the account using the estimated transaction includes:
generating an approval notification associated with the new transaction; and
causing the generated approval notification to be sent to one or more entities associated with the new transaction, wherein the one or more entities associated with the new transaction include a merchant, an acquirer, or an issuer.

10. The computerized method of claim 8, further comprising:
estimating future account behavior of the account using the estimated transaction;
determining that the estimated future account behavior indicates a reduction in user loyalty with respect to the account; and
recommending a promotional offer to be offered to a user of the account, whereby the reduction in user loyalty with respect to the account is less likely.

11. The computerized method of claim 8, further comprising:
generating, by the transformer model, a second output group of embeddings based on the provided groups of embeddings;
transforming the second output group of embeddings to form a second estimated transaction, wherein the second estimated transaction is associated with the account with which the obtained group of transactions is associated;
determining a difference between the second estimated transaction and a second new transaction associated with the account exceeds a threshold; and
generating a preemptive fraud indicator based on the determined difference exceeding the threshold.

12. The computerized method of claim 8, further comprising:
generating an inventory management indicator associated with the estimated transaction, wherein the inventory management indicator indicates, to a receiving merchant, a need to order an item with which the estimated transaction is associated; and
causing the generated inventory management indicator to be sent to a merchant with which the estimated transaction is associated.

13. The computerized method of claim 8, further comprising:
receiving a natural language query associated with the account;
generating a natural language query response based on the estimated transaction; and
responding to the received natural language query with the generated natural language response.

14. A computer storage medium has computer-executable instructions that, upon execution by a processor, cause the processor to at least:
obtain a group of transactions associated with an account;
convert the group of transactions into a group of transaction strings using a subset of transaction features of the group of transactions;
for each transaction string in the group of transaction strings, tokenize the transaction string using a tokenizer to obtain an associated transaction token, wherein the tokenizer includes a token vocabulary that associates transaction strings with transaction tokens;
provide transaction tokens associated with the group of transaction strings to an ML model as input;
generate, by the ML model, an estimated transaction token based on the provided transaction tokens;
transform the generated estimated transaction token into an estimated transaction using a de-tokenizer associated with the tokenizer, wherein the estimated transaction is associated with the account with which the obtained group of transactions is associated; and
approve a new transaction associated with the account using the estimated transaction, wherein the estimated transaction is compared to the new transaction.

15. The computer storage medium of claim 14, wherein converting the group of transactions into the group of transaction strings using a subset of transaction features of the group of transactions includes:
identifying a numeric transaction feature of the subset of transaction features;
determining a numeric value of the identified numeric transaction feature for a transaction of the group of transactions; and
converting the determined numeric value of the identified numeric transaction feature into a categorical feature value of a categorical feature that is associated with a numeric value range of the numeric transaction feature, wherein the transaction string of the transaction includes the categorical feature value to which the determined numeric value was converted.

16. The computer storage medium of claim 14, wherein approving the new transaction associated with the account using the estimated transaction includes:
generating an approval notification associated with the new transaction; and
causing the generated approval notification to be sent to one or more entities associated with the new transaction, wherein the one or more entities associated with the new transaction include a merchant, an acquirer, or an issuer.

17. The computer storage medium of claim 14, wherein the computer-executable instructions, upon execution by the processor, further cause the processor to at least:
estimate future account behavior of the account using the estimated transaction;
determine that the estimated future account behavior indicates a reduction in user loyalty with respect to the account; and
recommend a promotional offer to be offered to a user of the account, whereby the reduction in user loyalty with respect to the account is less likely.

18. The computer storage medium of claim 14, wherein the computer-executable instructions, upon execution by the processor, further cause the processor to at least:
generate, by the ML model, a second estimated transaction token based on the provided transaction tokens;
transform the second generated estimated transaction token into a second estimated transaction using a de-tokenizer associated with the tokenizer, wherein the second estimated transaction is associated with the account with which the obtained group of transactions is associated;
determine a difference between the second estimated transaction and a second new transaction associated with the account exceeds a threshold; and
generate a preemptive fraud indicator based on the determined difference exceeding the threshold.

19. The computer storage medium of claim 14, wherein the computer-executable instructions, upon execution by the processor, further cause the processor to at least:
generate an inventory management indicator associated with the estimated transaction, wherein the inventory management indicator indicates, to a receiving merchant, a need to order an item with which the estimated transaction is associated; and
cause the generated inventory management indicator to be sent to a merchant with which the estimated transaction is associated.

20. The computer storage medium of claim 14, wherein the computer-executable instructions, upon execution by the processor, further cause the processor to at least:
receive a natural language query associated with the account;
generate a natural language query response based on the estimated transaction; and
respond to the received natural language query with the generated natural language response.
